(19) United States
(12) Patent Application Publication
(10) Pub. No.: US 2007/0033522 A1
(43) Pub. Date: Feb. 8, 2007

(54) System and method for dynamic resizing of web-based GUIs

(76) Inventors: Frank Li-De Lin, Escondido, CA (US); Rachel Thuy Nguyen, San Jose, CA (US)

Correspondence Address: ROGITZ & ASSOCIATES, 750 B STREET, SUITE 3120, SAN DIEGO, CA, 92101, US

(21) Appl. No.: 11/398,138

(22) Filed: Apr. 4, 2006

Related U.S. Application Data
(60) Provisional application No. 60/704,736, filed on Aug. 2, 2005.

(51) Int. Cl. G06F 17/00

(52) U.S. Cl. 715/526; 345/698

(57) ABSTRACT

A HTML file defining a GUI is created and GUI elements defined therein for a default screen resolution can be reconfigured as appropriate when the GUI senses a new screen resolution.

This application claims priority to U.S. provisional patent application Ser. No. 60/704,736, filed Aug. 2, 2005, incorporated herein by reference.

### I. FIELD OF THE INVENTION

The present invention relates generally to dynamically reconfiguring graphical user interfaces (GUIs), and in particular Web-based GUIs, for changing screen resolutions and/or user resizing of the desired GUI window.

### II. BACKGROUND OF THE INVENTION

In the past few years, there has been a convergence of personal computers and consumer electronics devices. This is because harnessing the power and flexibility of the PC platform provides users with improved entertainment experiences. As understood herein, however, this convergence is not without its challenges, one of which is designing GUIs that can work with plural screen resolutions, e.g., that can be displayed for use with a standard definition (4×3) television screen and that can also be displayed for use with a high definition (16×9 or 16×10) screen. Furthermore, a user sometimes is permitted to establish the size of a GUI window on a screen, further complicating GUI design.

As further understood herein, solutions that require custom graphics engines or built-in browser zoom functions suffer from being highly complex and/or poor performers, particularly when used in non-native environments (i.e., with screen resolutions that depart from a default resolution). With these critical recognitions in mind, the invention herein is provided.

### SUMMARY OF THE INVENTION

A method for presenting a GUI includes establishing a Web-based template defining a default GUI corresponding to a default screen resolution. The default GUI includes plural GUI elements such as but not limited to buttons, and each element has corresponding parameters in the template. A GUI is presented on a display with the parameters altered as appropriate for a resolution different from the default resolution.

Plural templates corresponding to respective default screen resolutions may be established. The GUI element parameters may include element width, element length, element distances from at least two orthogonal GUI window boundaries, and size of font displayed in an element. In some implementations element layout can be changed from a default layout when a screen resolution different from the default resolution is detected.

In another aspect, a processor executes logic to scale a GUI for a screen resolution that is different from a default screen resolution. The logic includes altering a number of GUI elements in a row of elements.

In yet another aspect, a system includes an audio-video device such as a TV and a processor coupled to the TV to display a GUI on the TV. The GUI includes a column of control buttons, with at least some control buttons being selectable to alter an order of presentation of select buttons. The GUI also includes at least two columns of select buttons. A select button can be used to select a respective multimedia stream for playing thereof on the TV.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of one non-limiting implementation of the present invention;

FIG. 2 is a screen shot of a non-limiting GUI configured for a first screen size or user-defined GUI window size;

FIG. 3 is a screen shot of a non-limiting GUI configured for a second screen size or user-define GUI window size;

FIG. 4 is a screen shot of another non-limiting GUI configured for a first screen size or user-defined GUI window size;

FIG. 5 is a screen shot of the other non-limiting GUI configured for a second screen size or user-defined GUI window size; and

FIG. 6 is a flow chart of a non-limiting implementation of the reconfiguring logic.

### DETAILED DESCRIPTION OF THE PREFERRED EMBODIMENT

Referring initially to FIG. 1, a system is shown, generally designated 10, that includes an audio-video system 12 having a video screen 14, all or a portion of which may be used to present a graphical user interface (GUI) display in a GUI window 16. By way of non-limiting example, the A/V system 12 may include a TV alone or in combination with an internal or external game console and/or an internal or external disk player, and the A/V system 12 accordingly may include a processor 18 and data storage 20 either within a housing of a TV or within a separate set-top box or other computing device. The processor 18 may access data in the data store 20 to execute the logic described herein.

As shown in FIG. 1, the system 10 may also include a disc changer 22 that can have one or more drives, e.g., optical drives for reading optical discs and sending the resultant multimedia stream to the A/V system 12 for playing in response to user manipulation of the GUI. Accordingly, the system 10 also can include a remote control device 24 or other suitable user-manipulable input device, including voice recognition devices, that can be used to operate the A/V system 12 GUI.

In some implementations, the resolution of the screen 14 may be standard definition, e.g., 4×3, or it may be high definition, e.g., 16×9 or 16×10, or it may be other resolutions. Regardless, as set forth further below the GUI is automatically resized and in some instances reconfigured as appropriate for the screen resolution and/or user-defined GUI window 16 size. In any case, the processor 18 may communicate with the Internet 26 if desired.

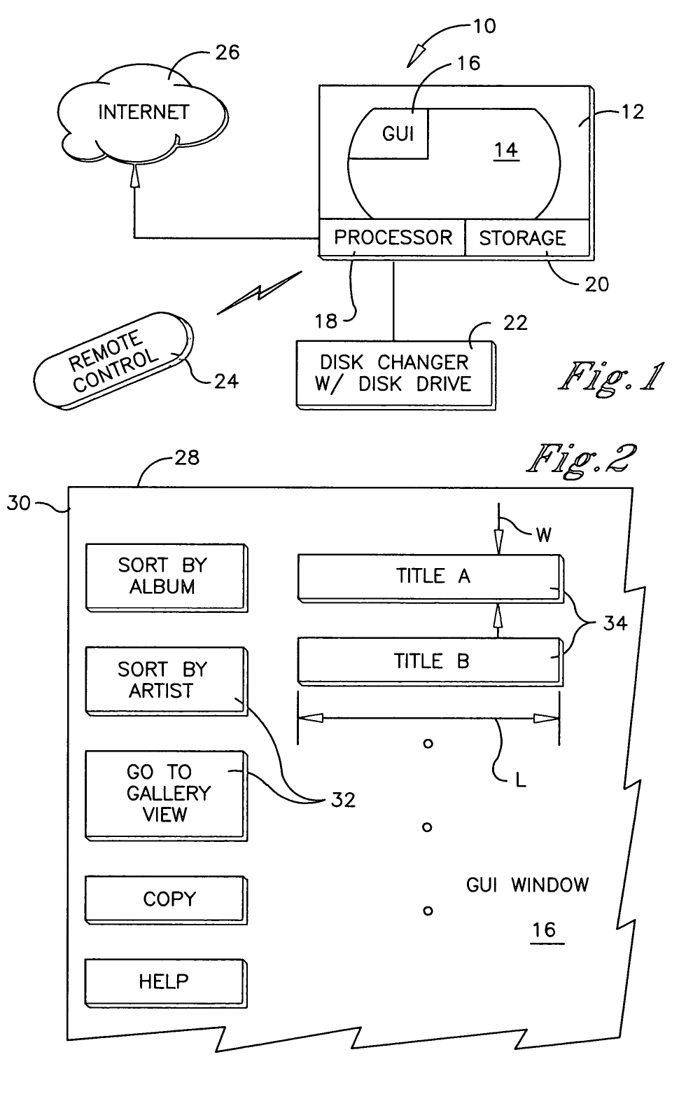

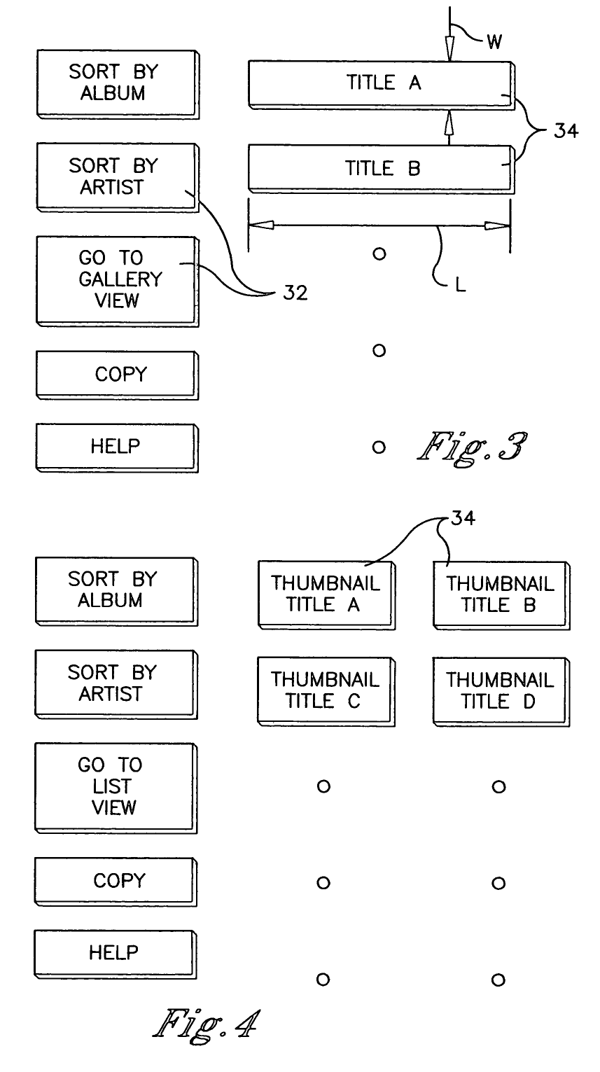

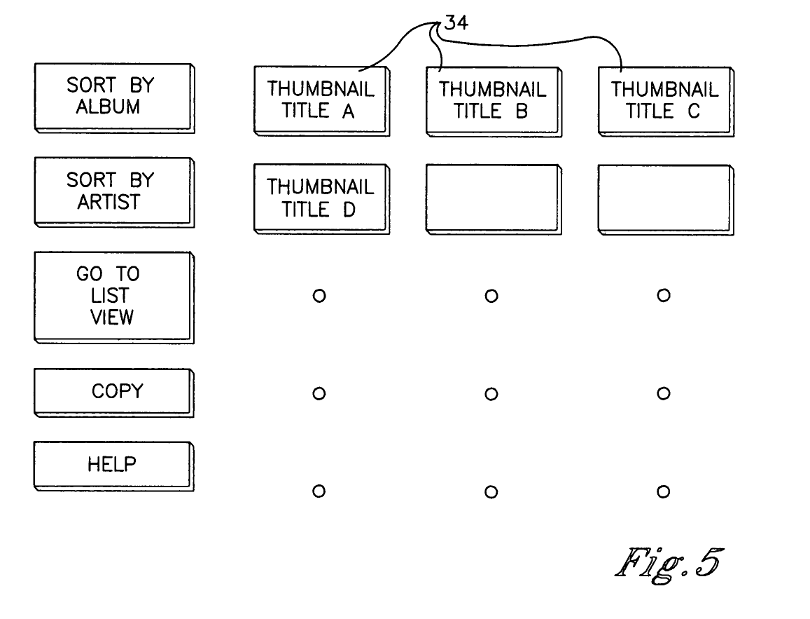

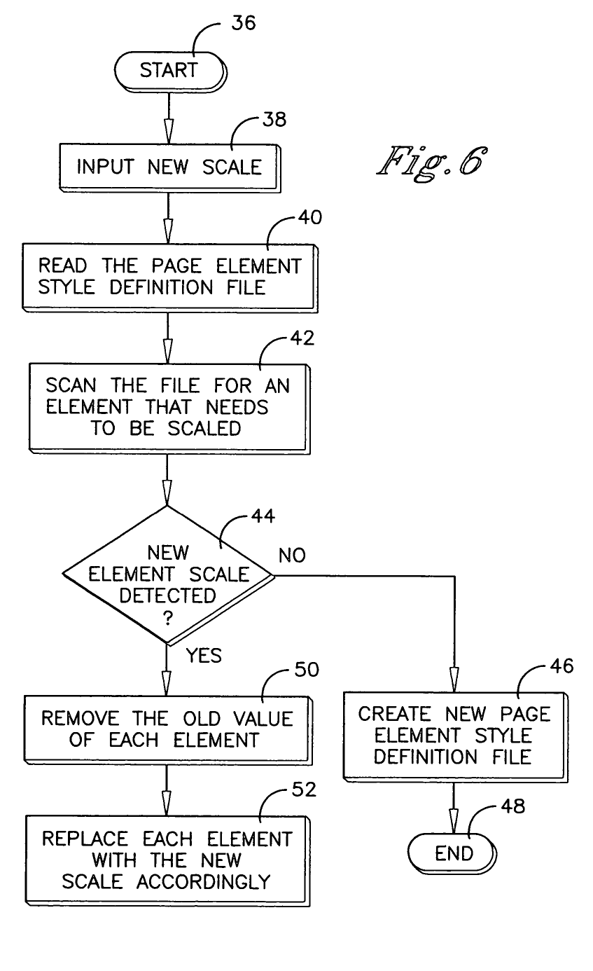

FIGS. 2-5 show how the present GUI appears on various screens of different resolutions after the logic of FIG. 6 and the below pseudo-code has been executed. In FIG. 2, the GUI window is defined in part by orthogonal boundaries such as a top boundary 28 and a left boundary 30. The GUI itself may include control buttons 32 and select buttons 34 that are arranged in accordance with selections of the control buttons 32. For instance, the user can click on a control button 32 to cause the select buttons 32 to be sorted by album or by artist as shown. Also, the user can elect to display select buttons as thumbnails (discussed further below in reference to FIGS. 4 and 5) instead of in the list format shown in FIGS. 2 and 3 by appropriately manipulating a “gallery view” control button. Copy and help control buttons can also be provided to invoke copy and help functions in accordance with principles known in the art.

In any case, as shown using the select buttons 34 as non-limiting examples, a button of the GUI may have a width “W” and a length “L” when displayed on a screen of a first resolution as shown in FIG. 2, and a different width “W” and/or length “L” when displayed on a screen of a second resolution as shown in FIG. 3, it being understood that the overall button size and/or the ratio of length to width may change between resolutions as shown. The same principle can be used to change button size and configuration for the same screen resolution but different user-defined GUI window 16 sizes.

Moreover, the screen layout of GUI elements can change depending on screen resolution and/or user-established GUI window size. This can be seen in reference to FIGS. 4 and 5, in which the select buttons have been reconfigured from a simple title listing to thumbnails of the underlying object (e.g., a disc-borne movie) being selected. In FIG. 4, two columns of select buttons 34 are established in the GUI window 16, whereas in FIG. 5, for a wider screen resolution or for a wider user-defined GUI window, the select buttons 34 may be rearranged into three columns as shown. When the select buttons are configured as thumbnails, the control button 32 that had formerly indicated “go to gallery view” may change to indicate “go to list view”, so the user can revert to the list-type select buttons 34 shown in FIGS. 2 and 3.

In general, the logic to produce functionality discussed above begins with the establishment of a default GUI button size and arrangement for a default resolution or resolutions. In one non-limiting implementation, a default layout is established using a Web-based language such as hypertext mark-up language (HTML) or XML, and may define GUI elements using a style sheet. In one implementation, each GUI button is defined terms of its width “W” and length “L”, as well as in terms of its position from, e.g., the left edge 30 and top edge 28 of the GUI window 16. The size of the font displayed in the button can also be established. One and only one template may be established for a default resolution, with resizing and reconfiguring of GUI elements being calculated on the fly, or multiple templates may be established, one for each common resolution (e.g., one for 4×3, one for 16×9, one for 16×10).

To display the GUI, a Web browser can be invoked. To re-size and/or to re-configure the GUI display in accordance with the above disclosure, the logic of FIG. 6 may then be invoked.

Commencing at start state 36 the logic moves to block 38 to obtain the resolution of the screen on which the GUI is to be displayed. Ordinarily the processor 18 possesses screen resolution information. Proceeding to block 40, the appropriate GUI template is read from, e.g., the storage 20. When only a single default template is used, it is read at block 40, but when plural templates are used, the one that most closely matches the detected resolution is read.

Proceeding to block 42, the template file is scanned to find any elements that might require re-sizing and/or re-configuring, as might occur when the assumed screen resolution of the default template does not match the actual screen resolution or when a user re-defines the GUI window size. Decision diamond 44 merely indicates that when a new element scale is not known, the logic may flow to block 46 to create a new GUI file, ending at state 48.

On the other hand, when the new scale is known and another template fitting the new scale is available, the logic flows to block 50 to remove the old value of the affected elements and to replace them at block 52 with new scale values from the new template. Alternatively, the new values may be calculated on the fly when no new template exists in accordance with principles above. For instance, one or more of the width “W”, length “L”, position from, e.g., the left edge 30 and top edge 28 of the GUI window 16, and font size of the text displayed in the element may be modified as appropriate to fit inside the new GUI window area. For example, the GUI elements can be enlarged or shrunk in proportion to the ratio between the current screen resolution and new screen resolution.

The pseudo code below provides further non-limiting details that may be implemented. The timer mentioned in the code below is implemented to avoid excessive reconfiguring when a user might quickly and repeatedly input re-sizing commands.

/*
The pseudo-code below implements a method of dynamically resizing the elements in
an HTML user-interface
/* These variables will be used throughout this implementation */
Timer tScheduledTimer = null; // this variable indicates whether or not

| | |
|---|---|
| | // a resize timer has been |
| scheduled | |
| TIMEOUT = ZZZZZZZZZZZ; | // this variable contains a timeout |
| value that | |
| | // determines how often |
| dynamic resizing occurs | |
| DEFAULT_SCALING = ZZZZZZ; | // this value sets the base |
| dimensions of the | |
| | // GUI elements. The |
| dynamically resized elements | |
| | // will be based on this |

```
dimension.
/*
    Name: OnDetectScreenSizeChange( )
    Description: This function or callback detects when the screen dimensions
                have changed. It will not directly change the elements, but
instead
                schedule the process to make the change. The underlying reason
for
                this is that the screen may change multiple times within a short
                period of time. Processing the dynamic resizing for each of
these
                times would cause an inordinate amount of processing.
    Inputs: none
    Outputs: none
*/
function OnDetectScreenSizeChange( )
{
    // if there was previously a timer scheduled, cancel it and start a new one
    if( tScheduledTimer ) {
        function clearTimer( tScheduledTimer );
    }
    // now schedule a timer to begin a process at some future time (1 second? 2
seconds?)
    tScheduledTimer = function SetTimer(“ScheduleResizing( )”, TIMEOUT);
}
/*
    Name: ScheduleResizing( )
    Description: This function will be triggered after a scheduled resizing event
                has completed. It will calculate and create the new layout, then
                apply this new layout to the current user interface.
    Inputs: none
    Outputs: none
*/
function ScheduleResizing( )
{
    newScaling = function CalculateNewScaling( );
    newLayout = function CreateNewLayout( newScaling );
    function UseNewLayout( newLayout );
}
/*
    Name: CalculateNewScaling( )
    Description: This function will calculate the new ratio that should be
                used for the dynamic resizing process
    Inputs: none
    Outputs: The new ratio to use
*/
function CalculateNewScaling( )
{
    oldScaling = DEFAULT_SCALING;
    // get the new dimensions of the resized window. The actual method to
    // calculate this depends on the environment and platform that the
    // GUI client is hosted on.
    newDimensions = GetWindowDimensions( );
    newScaling = Scale(newDimensions, oldScaling);
    return newScaling;
}
/*
    Name: CreateNewLayout( )
    Description: This function will go through the individual GUI elements
                and reposition and resize their coordinates. Details for one
                possible architecture of this process is included with this
                innovation.
    Inputs: none
    Outputs: The new layout to use
*/
function CreateNewLayout( newScaling )
{
    for each ItemOnPage( element )
    {
        newLayout(element) = RepositionAndResize( element, newScaling );
    }
    return newLayout;
}
/*
    Name: UseNewLayout( )
    Description: This function will trigger the UI client to use the new layout.
    Inputs: newLayout
    Outputs: none
*/
function UseNewLayout( newLayout )
{
    // Use the new layout. The actual method to implement this depends
    // on the environment and platform that the GUI client is hosted on.
    CurrentPage.layout = newLayout;
}
```

In addition to the above, the present invention recognizes that when a button or other GUI object is reduced, text within the object may be too long to present in the smaller area. Thus, the maximum amount of text for a given font size that can fit within the new, smaller GUI object area is calculated, and then the intended text is cropped to this amount. One non-limiting way to crop the text includes replacing as many end characters of the text as needed to fit within the new area with a post-fix such as three periods, e.g., “the sky is blue and rainy” becomes “the sky is b . . . ” Or, alpha-blending can be used to fade out text, e.g., “the sky is blue and rainy” becomes “the sky is blue”, and the last few letters of “blue” can fade away to entirely transparent.

While the particular SYSTEM AND METHOD FOR DYNAMIC RESIZING OF WEB-BASED GUIs as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. A method for presenting a GUI, comprising:
establishing at least one Web-based template defining a default GUI corresponding to a default screen resolution, the default GUI including plural elements, each element having corresponding parameters in the template; and
presenting a GUI on a display with the parameters altered as appropriate for a resolution different from the default resolution.

2. The method of claim 1, comprising establishing plural templates corresponding to respective default screen resolutions.

3. The method of claim 1, wherein the parameters include element width.

4. The method of claim 1, wherein the parameters include element length.

5. The method of claim 1, wherein the parameters include element distances from at least two orthogonal GUI window boundaries.

6. The method of claim 1, wherein the parameters include size of font displayed in an element.

7. The method of claim 1, wherein the parameters include element width, element length, element distances from at least two orthogonal GUI window boundaries, and size of font displayed in an element.

8. The method of claim 1, wherein element layout is changed from a default layout when a screen resolution different from the default resolution is detected.

9. A processor executing logic to scale a GUI for a screen resolution different than a default screen resolution, the logic including altering a number of GUI elements in a row of elements.

10. The processor of claim 9, wherein the logic includes establishing plural templates corresponding to respective default screen resolutions.

11. The processor of claim 9, wherein each GUI element includes parameters including element width, element length, element distances from at least two orthogonal GUI window boundaries, and size of font displayed in an element.

12. The processor of claim 9, wherein element layout is changed from a default layout when a screen resolution different from the default resolution is detected.

13. A system, comprising:
a audio-video device;
a processor controlling at least in part a display of the audio-video device to display a GUI in at least a portion of the display, the GUI comprising:
at least one column of control buttons, at least some control buttons being selectable to alter an order of presentation of select buttons; and
at least two columns of select buttons, a select button being selectable to select a respective multimedia stream for playing thereof on the audio-video device.

14. The system of claim 13, wherein the GUI is defined at least in part by at least one Web-based template defining a default GUI corresponding to a default screen resolution, the default GUI including plural GUI elements, each GUI element having corresponding parameters in the template.

15. The system of claim 14, wherein plural templates corresponding to respective default screen resolutions are established.

16. The system of claim 14, wherein the parameters include GUI element width.

17. The system of claim 14, wherein the parameters include GUI element length.

18. The system of claim 14, wherein the parameters include GUI element distances from at least two orthogonal GUI window boundaries.

19. The system of claim 14, wherein the parameters include GUI element width, GUI element length, GUI element distances from at least two orthogonal GUI window boundaries, and size of font displayed in an element.

20. The system of claim 14, wherein GUI element layout is changed from a default layout when a screen resolution different from the default resolution is detected.
